(19) United States
(12) Patent Application Publication
(10) Pub. No.: US 2003/0051143 A1
(43) Pub. Date: Mar. 13, 2003

(54) Watermarking a digital signal using signal meta data

(76) Inventors: Ravi Razdan, Solana Beach, CA (US); Jonathan Peter Hughes, San Diego, CA (US)

Correspondence Address: STREAMTONE, INC, 2683 VIA DE LA VALLE, G-427, DELMAR, CA, 92014, US

(21) Appl. No.: 09/948,679

(22) Filed: Sep. 10, 2001

(51) Int. Cl. H04L 9/00

(52) U.S. Cl. 713/176

(57) ABSTRACT

A method is described for finding areas of a signal which survive multiple transcodings and signal conversions. Then using these identified areas and associated meta data to insert in real-time hard to detect traceable watermarks in a secure and robust manner. Also a means of extracting the marks from pilfered or suspect digital signal using such information.

### FIELD OF INVENTION

This invention relates to distribution, audit trailing of copyrighted works on operator networks as well as the identification of sources of unauthorized distribution.

### BACKGROUND OF THE INVENTION

The current focus on authorized digital distribution of content such as music, video, books, software, images has brought forth numerous copy protection techniques. The focus of such techniques is to prevent piracy and unauthorized use of such copy protected content by end user. Some of these techniques rely on a “watermark” or an imperceptible signal added to base signal(content) to determine the usage rights for that content.

Nevertheless these techniques are less than adequate since the moment the content is channeled to an output device the content is easily pilfered. Such techniques involve include using output jacks on popular consumer electronic devices, fake software driver on PCs etc. As such 100% guaranteed protection of copyrighted content is an impossibility and piracy to a certain degree is inevitable.

This scenario brings forth the need for a fool proof mechanism to tag digital content as it moves along the digital distribution chain from the creators, distributors, network operators and consumer. This mechanism will provide the necessary tracking, audit trial, piracy deterrent besides identifying the leaks in the value chain resulting in enabling a healthy ecosystem for digital distribution.

Such mechanism needs to satisfy following requirements to be useful and acceptable. It should not effect the base signal quality while at the same time be densely embedded to be extracted from small content samples. It should be robust and secure to survive removal techniques such as introduction of phase changes, amplitude, sampling frequency and pitch shifts.

Also addition of signals inherently different from the base signal can be easily identified and are thus susceptible to easy removal. Plus any attack which adds noise should render the base signal unusable from the user perspective. It should survive collusion attacks were the signal is averaged by multiple parties in a collusion attacks.

Further more it should be real time in nature given the on demand nature of usage of digital content. The unforeseen compromising of one copy of watermarked content should not lead to the same attack by other users on the same or different content. Also the ability to mark the same content multiple times to track the movement of the content through the mastering, packaging, distribution and consumption is inherently required.

Given the impossibility of preventing copying of multimedia content after delivery to an output device the current invention intends to provides guaranteed traceability or illegal content destruction via traceable digital watermarks. Per transaction watermarking at the point of delivery allows the copyright holder to determine the exact source of violations to the actual entity or individual which was not possible with existing staged watermarks. The robustness and spread spectrum capability of watermark prevents removal via DSP techniques since that would mean modifying relevant portion of the content. Such modification will contaminate the content thus rendering it unusable. This prevents the violator from profiting.

The existing watermarking techniques cannot survive such attacks as the public trials of these technologies have shown. They are also not capable of providing the desired capabilities sought by current market needs. Hence a new mathematical approach for watermarking is needed which is invertible to phase, amplitude, sampling and pitch changes thus surviving the attacks. Secondly the same generic technique should work for different signal or content domains such as video, images, text and software. Third it should support real-time transactions and recognize and skip existing marks on a per marked content. Fourth the watermarks need to be non fragile so it can be extracted from a noisy base signal as long as the signal is humanly recognizable. Fifth the extraction process should be simple, fast and not dependent on the availability of existing content.

The current invention describes the StreamTone inverse wavelet transform a new general purpose mathematical technique to insert and extract watermarks to aid in content tracing and audit.

### BRIEF SUMMARY OF INVENTION

Accordingly, several objects and advantages of my invention are the ability to find areas of the signal to encode the watermark into that will survive subsequent transcoding cycles and the ability to utilize this information to perform the watermarking of the signal in real-time at the point of delivery.

The concept of identifying signal areas for watermarking or meta-data or content fingerprint aids in real-time watermark providing non-repudiation besides providing an audit trial on the content as it moves from network to network between copyright holder and network distributors. The multiple watermark layers provide an audit history even with a fraction of the original content. Also the current watermark is adapted to the base signal thus attempts of removal of watermark will degrade the base signal considerably.

Thus the current invention is geared toward the real time just in time content networks with a seamless traceability. This is unlike the current watermarks which are packaged or staged watermarks lacking the realistic piracy deterrent current invention provides.

### BRIEF DESCRIPTION OF THE SEVERAL VIEWS OF THE DRAWING

FIG. 1—the analysis process

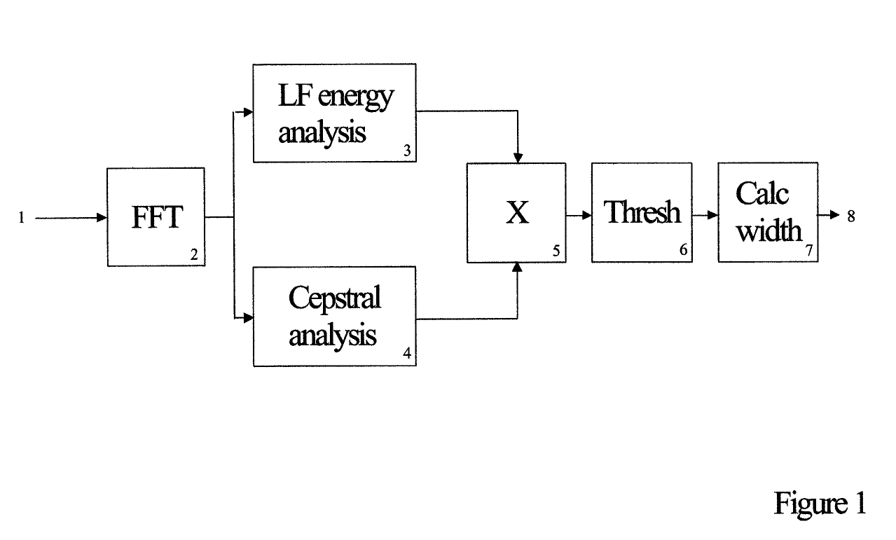

FIG. 2—the watermark insertion process

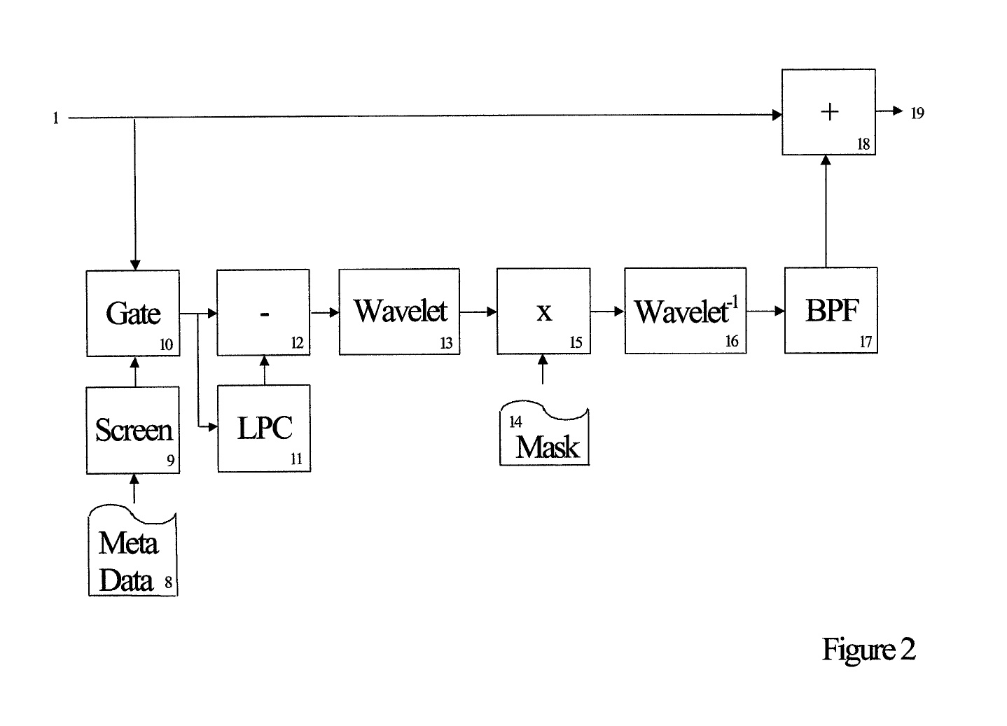

FIG. 3—the watermark extraction process

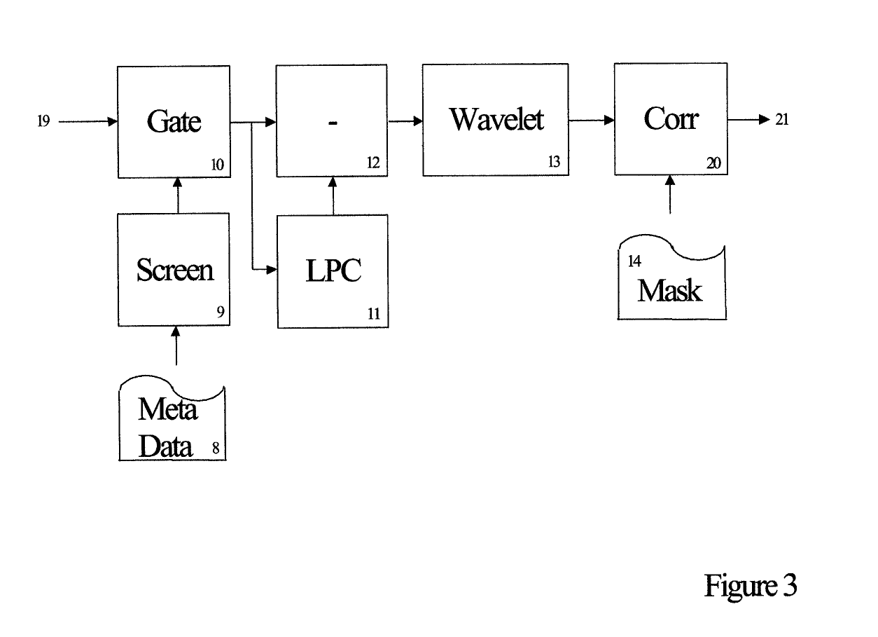

### DETAILED DESCRIPTION OF THE INVENTION

Steps Involved in the Analysis of a Signal:

The purpose of the analysis is two-fold. One purpose is to find areas of the signal that can be watermarked which will withstand subsequent transcodings and signal conversions. The other purpose is to allow for the pre-computation of these areas so that real-time insertion can be performed since the time required to identify stable segments is large.

1—Compute the frequency spectrum (2) of the signal (1). This is done by applying a windowing function to a section of the signal and performing a fast fourier transform to the windowed data. The window is then moved progressively along the signal with some degree of window overlap and the operation repeated.

2—Spectral analysis (3) is performed on the frequency coefficients in each window. This analysis comprises calculating the energy of each window in a low frequency band. The analysis then finds windows which have high energy relative to their neighbors.

3—Additional analysis (4) is performed on the frequency coefficients in each window in step 1. A fast fourier transform is calculated based on the logarithm of the absolute magnitude of each window coefficient. This is equivalent to performing a Cepstral transform on the original signal.

4—A new signal is derived from the concatenation of each low order Cepstral coefficient from the step 3. This signal is smoothed using a moving average filter. The resultant signal is analyzed to find samples that are large relative to their neighbors.

5—The output from steps 2 and 4 is combined (5) and if the result passes a threshold value (6), the window in the original signal stream it represents, becomes a segment candidate for watermarking and is optionally stored for later use (8).

6—The width of each segment discovered in step 5 is then calculated (7) by examining the local energy of each window following the one identified in step 5. Once the local energy has fallen to some value below the energy of the initial window then the segment has ended. The segment width is optionally stored for later use (8).

Steps Involved in the Insertion of Watermarks into a Signal:

The process of insertion takes the digital signal and inserts watermarks at the segmentation points identified above. The signal's energy is reduced and the watermark added to that reduced signal thus keeping the watermark hidden within the noise level of the signal. The watermarked segments are then added back into the original signal to produce the watermarked version.

1—The signal (1) is split into two paths. One path is used to perform mixing with the watermark signal and the other is sent to the watermarking processes.

2—The segmentation data (8) calculated during the analysis phase are screened (9) to ensure that they are large enough to hold the watermark to be inserted. Segments failing to meet this test are excluded from the insertion process.

3—The watermarking signal is gated (10) with the filtered segmentation data previously derived from the signal (1). This allows multiple watermarks to be inserted within the signal.

3—The gated signal is passed to a linear predictive coder (11) and the output from that is removed (12) from the gated signal to leave a residual signal.

4—The residual signal is transformed using a wavelet transform (13).

5—The wavelet coefficients are then multiplied (15) by a pre-scaled coefficient mask (14). This mask is determined through a one way transform from the actual watermark symbol to be inserted. This has the effect of spreading the symbol across the signal's frequency spectrum at that point segment point.

6—The resultant coefficients are then transformed back through an inverse wavelet transform (16).

7—The transformed signal is fed through a band pass filter (17) to shape the watermark signal so that distortions introduced during the inverse wavelet transform step are minimized.

8—The filtered signal is then added (18) to the original signal from step 1 to produce the watermarked version (19).

Steps Involved in the Extraction of Watermarks from a Signal:

The process of extraction proceeds in much the same way as described above for analysis and insertion. Only this time once the wavelet coefficients have been calculated they are then correlated with all possible watermarks to determine if one or more is present.

1—The segmentation data (8) calculated during the analysis phase are screened (9) to ensure that they are large enough to hold the watermark to be extracted. Segments failing to meet this test are excluded from the extraction process.

2—The watermarking signal is gated (10) with the filtered segmentation data previously derived from the signal (1). This allows multiple watermarks to be extracted from within the signal.

3—The gated signal is passed to a linear predictive coder (11) and the output from that is removed (12) from the gated signal to leave a residual signal.

4—The residual signal is transformed using a wavelet transform (13).

5—The wavelet coefficients are then correlated (20) with the known set of pre-scaled symbol coefficient masks (14) to determine if a watermark has been inserted. If the correlation exceeds a predetermined threshold value then a particular symbol (21) has been found.

While my description contains many specificities, these should not be construed as limitations on the scope of the invention, but rather as an exemplification of one preferred embodiment thereof.

Accordingly, the scope of the invention should be determined not by the embodiment illustrated, but by the appended claims and their legal equivalents.

1. A method of analyzing the signal to identify the ideal signal segments to watermark, the method comprising:
an analysis of the energy contained in the signal of a chosen frequency band;
an analysis of the lowest order Cepstral coefficients of the signal;
the combination of these analyses to form a measurement of segmentation suitability;
the selection of signal portions that exceed the segmentation suitability threshold; and the recording of those potions for later use.

2. The method of compact representation of segment information in 1 via a meta-data or fingerprint, the method comprising:
the formation of a hyper-dimensional vector to describe the segment information by assigning one offset and one extent to each element in the vector; and the recording of the fingerprint for later use in a database.

3. The method in claim 2 wherein fingerprint is used for pattern matching and general content identification, the method comprising:
the computation of the fingerprint for the signal to be matched; and
the comparison of the fingerprint with those contained in the fingerprint database to find the best match.

4. The method in claim 2 wherein fingerprint is used to correlate a content signal stream to suggest similar content, the method comprising:
the computation of the fingerprint for the signal to be matched; and
the comparison of the fingerprint with those in the fingerprint database to suggest other content closely related.

5. A method of using a pre-computed fingerprint to insert watermarks in real time, the method comprising:
the splitting of the signal into the portions to be watermarked using the fingerprint as a splitting template;
the removal of predictable information from the signal using a linear predictive coder;
the transformation of the remaining information using a wavelet transform;
the modulation of the wavelet transform coefficients using a randomly generated bit pattern which represents the watermark to be inserted;
the transformation of the modulated wavelet transform coefficients back to the domain of the original signal;
the filtering of the transformed signal to fit the frequency content profile of the original signal; and
the addition of the transformed and original signal to produce the watermarked signal.

6. A method of using pre-computed fingerprint to extract watermarks in real-time, the method comprising:
the splitting of the signal into the portions in which potential watermarks might reside using;
the fingerprint as a splitting template; the removal of predictable information from the signal using a linear predictive coder;
the transformation of the remaining information using a wavelet transform;
the comparison of the wavelet transform coefficients against all known permutations derived from the set of possible watermark random bit patterns; and
the selection of the watermark that correlates highest with the wavelet transform coefficients providing the correlation is greater than a predetermined threshold.
